(19) United States
(12) Patent Application Publication
(10) Pub. No.: US 2012/0290343 A1
(43) Pub. Date: Nov. 15, 2012

(54) Work Order Audit System

(76) Inventors: William R. Bradley, Las Vegas, NV (US); David A. Blackburn, San Diego, CA (US); Bryan Madison, San Diego, CA (US); Marlon B. Akins, San Diego, CA (US); Christopher Robert Hetherly, Apple Valley, CA (US); Aaron Freeman, La Mesa, CA (US); William Clark Dale, San Diego, CA (US)

(21) Appl. No.: 13/107,514

(22) Filed: May 13, 2011

(51) Int. Cl. G06Q 10/00

(52) U.S. Cl. 705/7.11

(57) ABSTRACT

A system for auditing and analyzing work performed by other individuals is disclosed. Data is imported into the system, where the data represents one or more elements of work performed at one or more locations. This data is parsed out into individual items to be audited. These items, along with a number of questions with discrete answers are then transmitted by the system to one or more auditing technicians who audit the work performed by capturing one or more visual images. These visual images, along with answers to the questions are then transmitted back to the system. The system then saves the visual images and associated answers for archiving and generating reports.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of auditing systems, and more specifically toward a system for auditing and analyzing work performed by other individuals. Data is imported into the system, where the data represents one or more elements of work performed at one or more locations. This data is parsed out into individual items to be audited. These items, along with a number of questions with discrete answers are then transmitted by the system to one or more auditing technicians who audit the work performed by capturing one or more visual images. These visual images, along with answers to the questions, comments, and/or descriptions are then transmitted back to the system. The system then saves the visual images and associated answers for archiving and generating reports.

There are prior art systems available for inspecting real property. These systems involve scheduling and/or dispatching one or more inspectors to a location to generate a report, and then make that report available to one or more users. The focus of these reports is the value of the asset and obtaining its current condition. Other systems involve obtaining information on repairs that need to be performed at a specific location, and then dispatching vendors to make said repairs. However, no means or method is disclosed on verifying the condition of work performed. Further systems aid insurers in assessing the value of and actual damage incurred by a particular property. Since insurers are more interested in the value of the original assets and the cost of replacing it, these systems have no ability to deal with how the repairs or work was performed, much less whether it was performed at all.

Thus there has existed a long-felt need for a system that audits work performed on real and/or personal property. The need continues for such a system that can process one or more work orders, automatically dispatch them to one or more technicians, receive a response from the technician that includes one or more visual images, and enable users to generate one or more reports from the received responses. The system should provide a fast, convenient, and cost-effective means of auditing work performed at a variety of locations over a period of time.

### SUMMARY OF THE INVENTION

The current invention provides just such a solution by having a system for auditing and analyzing work performed by other individuals. Data is imported into the system, where the data represents one or more elements of work performed at one or more locations. This data is parsed out into individual items to be audited. These items, along with a number of questions with discrete answers are then transmitted by the system to one or more auditing technicians who audit the work performed by capturing one or more visual images. These images, along with answers to the questions, comments, and/or descriptions are then transmitted back to the system. The system then saves the images and associated answers for archiving and generating reports.

The system first accepts data that represents one or more work orders. Each work order includes information relevant to the work that was performed at a specific location (such as a particular unit in an apartment complex or a particular aircraft), the specific task performed (such as repairing a hole in drywall or replacing a tire on a truck), and other relevant information. The data is parsed and saved into a computer readable medium, such as into a database.

Each work order is then matched to an auditing technician. The system has a list of auditing technicians that includes relevant information to each technician. Using this list, the system matches each work order to the best auditing technician to audit the specific work order. The auditing technician is then notified of the pending work order to audit. The notification includes the work order data along with one or more questions with each question having two or more discrete answers.

After receiving the work order, the auditing technician reviews and audits the work order. This is preferably achieved by personally reviewing the work performed at the specific location, capturing one or more digital images, and answering the one or more questions associated with the work order. Additionally, comments and/or descriptions associated with the review of the work order may be recorded. The images and answers to the questions, along with descriptions and/or comments are then transmitted back to the system.

The system reads in the data transmitted by the auditing technician and saves it to a computer readable medium. This saved data is then made available to one or more users preferably through generating one or more reports. Furthermore, if an auditing technician reviews a work order that requires immediate attention, then a notification, known as an Issue for Review or IFR, may be sent to one or more users notifying them of the work order, the particular issues that require attention, and one or more images.

It is a principal object of the invention to provide a convenient, fast, and efficient system for auditing work orders.

It is another object of the invention to provide a system for auditing multiple work orders at multiple locations.

It is a further object of this invention to provide a system for reviewing work order performance.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is an overview of the work order audit system and its interactions with various entities according to the embodiments of the current disclosure.

FIG. 2 is a flow diagram showing the acquisition of work order data into the work order audit system through the dispatching of a work order audit to a technician according to selected embodiments of the current disclosure.

FIG. 3 is a flow diagram showing the acquisition of a work order audit response and actions taken thereto according to selected embodiments of the current disclosure.

FIG. 4 is a flow diagram showing the generation of a report by a user according to selected embodiments of the current disclosure.

FIG. 5 is a flow diagram showing the creation of an account on the work order audit system according to selected embodiments of the current disclosure.

FIG. 6 is a flow diagram showing the acquisition of work order data into the work order audit system through the emailing of a work order audit to a technician according to selected embodiments of the current disclosure.

FIG. 7 is a flow diagram showing the steps taken by a technician to audit a work order and email the work order audit response back to the work order audit system according to selected embodiments of the current disclosure.

FIG. 8 is a flow diagram showing the acquisition of a work order audit response email and actions taken thereto according to selected embodiments of the current disclosure.

FIG. 9 is a flow diagram showing a user obtaining a report and/or data regarding work order audits according to selected embodiments of the current disclosure.

FIG. 10 is a schematic illustration of the work order audit system and its interactions with various entities according to embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

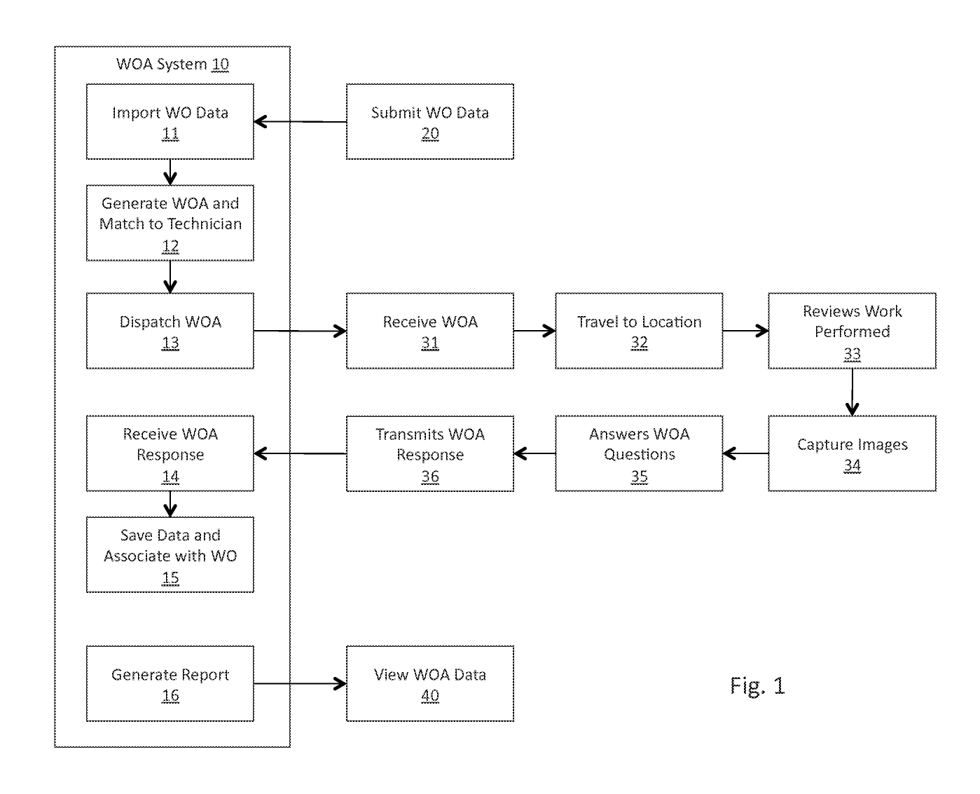

FIG. 1 is an overview of the work order audit system and its interactions with various entities according to the embodiments of the current disclosure. The work order audit system 10, or simply the system, imports work order data 11 submitted by a user 20, generates work order audit (WOA) data and matches the work order audit to a technician 12, and then dispatches the work order audit to the technician 13.

The technician receives the work order audit 31 and travels to the location specified in the work order audit 32, if not already there. The technician reviews the work performed 33 as outlined in the work order audit and captures one or more images 34. Questions associated with the work order audit must also be answered 35 and then the work order audit response is transmitted 36 back to the work order audit system 10.

The images captured may be still or video images, though still images are preferred. The resolution of a still image is generally higher, thereby allowing finer details to be observed. Further, the file size of a still image is usually far less than that of a video. Nonetheless, video images may be preferable in some instances where movement is a key element of reviewing the work performed pursuant to a work order audit. For example, if the work order requested that a light flash for one second every five seconds, then a video of such action would be appropriate.

The work order audit system 10 receives a work order audit response 14 and saves the data generated by the audit and associates it with the work order to which it relates 15, thereby enabling the system to generate reports 16 and allow users to view the work order audit data 40.

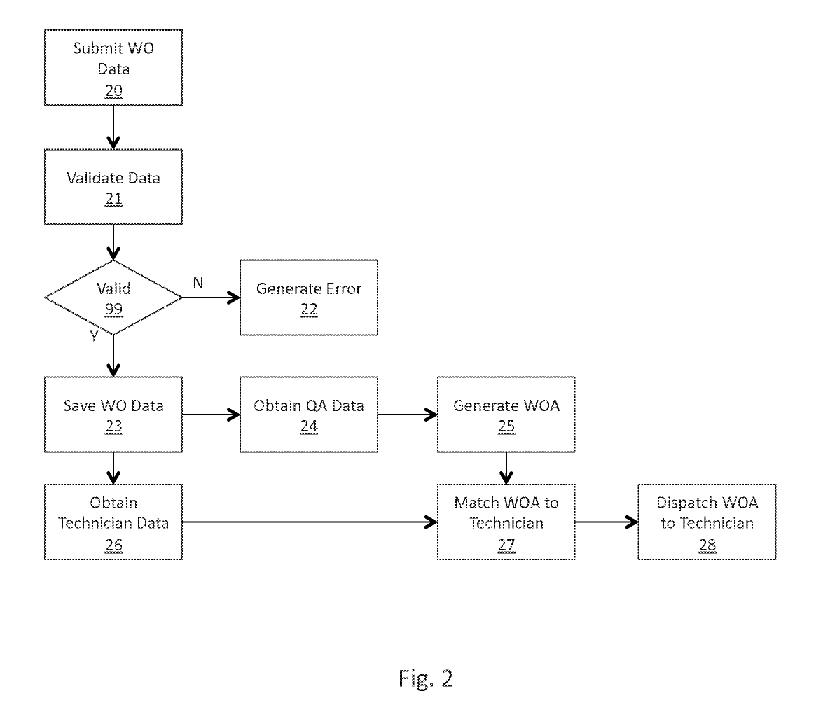

FIG. 2 is a flow diagram showing the acquisition of work order data into the work order audit system through the dispatching of a work order audit to a technician according to selected embodiments of the current disclosure. To start, work order data related to work performed at a location is submitted 20 to the work order audit system, which imports and validates the data 12. The work order data can be submitted to the work order audit system in a variety of formats and manners. For example, the work order data in a comma separated value (CSV) or extensible markup language (XML) format could be submitted to a server through a web browser using hypertext-transfer-protocol (HTTP) or hypertext-transfer-protocol-secure (HTTPS). Another example includes filling out a questionnaire in a browser and submitting that to a server also using HTTP. Yet another example includes transferring the work order data directly from a database on a remote computer to the work order audit system through some form of transmission control protocol (TCP). In any event, the data must be submitted to the work order audit system in such a fashion that it may be imported and parsed into the appropriate individual work orders and individual fields of that work order. In this manner, multiple work orders can be submitted to the work order audit system at once. After parsing out each individual work order, the work order audit system can then process each work order individually, either in series, parallel, or some combination thereof.

The work order data is validated 21 to ensure that it can be read and acted upon by the system. For example, a CSV file may be validated to ensure that it has the requisite number of fields and at least one record in which to act upon. If the system finds that the work order data is not valid 99, then the system will generate an error 22. The error may be displayed to the user, queued for notifying the user at a later date, or simply discarded. If the system finds that the work order data is valid 99, then the system continues on to saving the work order data 23. A computer readable medium is used to store the work order data.

The work order audit system then begins generating a work order audit by obtaining question and answer data 24. The question and answer data 24 includes one or more questions with a discrete number of answers, where the questions and answers are relevant to the work order audit currently being processed by the system. For example, the work order audit may include the question “Was the work completed?” to which the answers may be yes, no, or not sure. These questions and associated possible answers are preferably preset questions that are already stored within the system and included with each work order audit. However, these questions and associated possible answers may also be generated and/or stored remotely from the system and integrated into the work order audit at the time of generation. Additionally, there may be a set of questions and associated possible answers available to the work order audit system, but a subset of these questions used for particular work order audits. For example, the questions and possible answers may be selected by setting specific fields in the work order data file submitted by a user.

Determining which question and answers are applicable to a particular work order can be achieved in multiple different manners. First, the same questions may be used for each work order. Second, the user may specify the questions as a part of the submitted work order data. Third, the user may enter question and associated answers as a part of the account settings, where the questions may be applicable to every work order or a subset of work orders based upon the work order's category. Fourth, the system may select relevant questions from a list of predefined questions based upon the work order's category. Other manners for selecting questions may be implemented as will be apparent to users of the current invention. Note that the number of questions may vary as well, either systematically or randomly.

The work order audit includes data from the work order submitted to the system as well as a unique identifier and one or more questions with a discrete number of answers. The unique identifier enables the work order audit system to track responses it receives back from the technician. With this data in hand, the system can generate a work order audit 25.

Before the system can match the work order audit to a technician 27, it must obtain data on available technicians 26. A list of technicians is accessible by the work order audit system, whether stored locally or remotely. This list of technicians should include data relevant to the technician, such as name, contact information, address, available geographic areas, and available work types that the technician can audit. For example, a work order to audit a plumbing repair job in San Diego would cause the work order audit system to search for a technician in the San Diego area that is skilled, certified, or otherwise tagged as being able to audit plumbing repair jobs. In the event that multiple technicians are available to audit a work order, the system may randomly select a technician, select a technician based on a round-robin system, or using another method that is readily apparent to those using the current invention. In a preferred embodiment, work order audits are group together by geographic location and assigned as a group to a qualified technician thereby an efficient work route that reduces travel costs.

Once the work order audit is generated 25 and matched to the technician 27, the work order audit is dispatched to the technician 28. Various means of notifying the technician may be used, such as email, postal mail, posting to a website, or transmission to a desktop or mobile app.

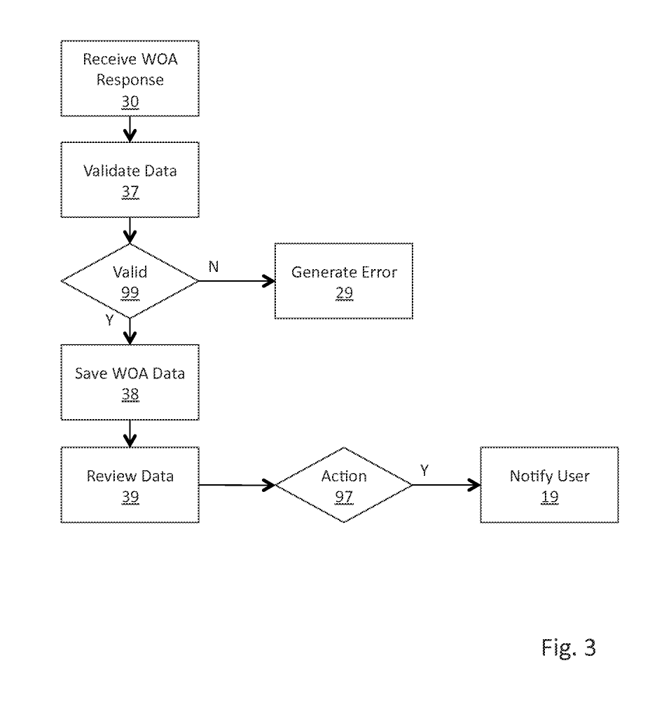

FIG. 3 is a flow diagram showing the acquisition of a work order audit response and actions taken thereto according to selected embodiments of the current disclosure. The system receives a work order audit response 30. The work order audit response includes at least the unique identifier, the answers to the questions, and the one or more images taken by the technician. While it is preferable that the work order audit response be transmitted to the system in the same manner it was transmitted by the system, this is not necessary.

The work order audit response is validated 37 to ensure that it can be read and acted upon by the system. For example, a CSV file may be validated to ensure that it has the requisite number of fields, at least one record in which to act upon, each record has a valid unique identifier, each question has an answer, and at least one image is associated. If the system finds that the work order audit response data is not valid 99, then the system will generate an error 29. The error may be displayed to the technician, queued for notifying the technician at a later date, displayed to a different entity, or simply discarded. If the system finds that the work order audit response data is valid 99, then the system continues on to saving the work order audit data 38 and associating the work order audit data with its corresponding work order data. This association may be achieved by setting corresponding identifiers in a relational database. As such, a computer readable medium is used to store the work order audit data.

After the work order audit data is saved 38, the data may go under further review 39. The work order audit system may review the answers to the questions of the work order audit and, depending upon the answer, may require further action. For example, one of the questions may be “Is further action required to complete the work order?” If the answer to this question is yes, then the system may take action 97. In this instance, the action would be to notify a user 19 that further action is required for a specific work order.

At any point during the work order audit process, users may generate reports using the work order audit system, though the reports are most beneficial after at least one work order has been audited. These reports enable users to view work order audit data as well as images associated with the work order audits. These reports are possible because of the questions and associated discrete number of possible answers. The work order audit system groups and counts the work order audits based upon these answers. Freeform answers to questions would not enable such a feature, as there would be a possible infinite number of groupings. For example, by requiring the technician to rate the quality of work on an integer scale from 1 to 5, a report can be generated on how many work orders were rated at 4 or above. If, on the other hand, it was an open ended question such as describe the quality of the work, a report could not be generated as each technician may describe the quality of the work using different words, terms, scales, and qualifiers. Therefore, it should be appreciated the questions with associated discrete number of possible answers are an important aspect of the current invention.

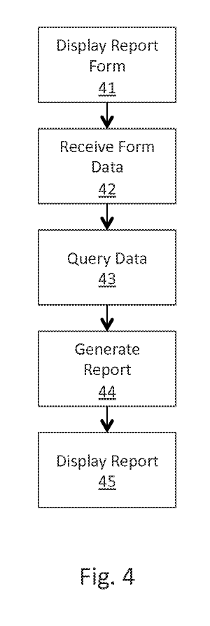

FIG. 4 is a flow diagram showing the generation of a report by a user according to selected embodiments of the current disclosure. A display report form 41 is produced by the system that enables users to select criteria to generate a report. The user submits this form to the system, which receives the form data 42. The system queries the stored data 43 to generate a report 44, which is displayed to the user 45.

An embodiment of the current invention is a work order audit system that is used to audit work performed on multiple units, such as apartment complexes or multiple homes. In this embodiment, tenants request various work to be performed on their units. Work orders are produced, and these work orders are fulfilled by the landlord (through its employees), third-parties, or both. However, once the work is performed, the landlord, in this case the user of the work order audit system, desires to audit the work performed to evaluate the quality, efficiency, value of the work performed, the responsible party, and other important and relevant information. The work order audit system of the current invention enables a user to do just that.

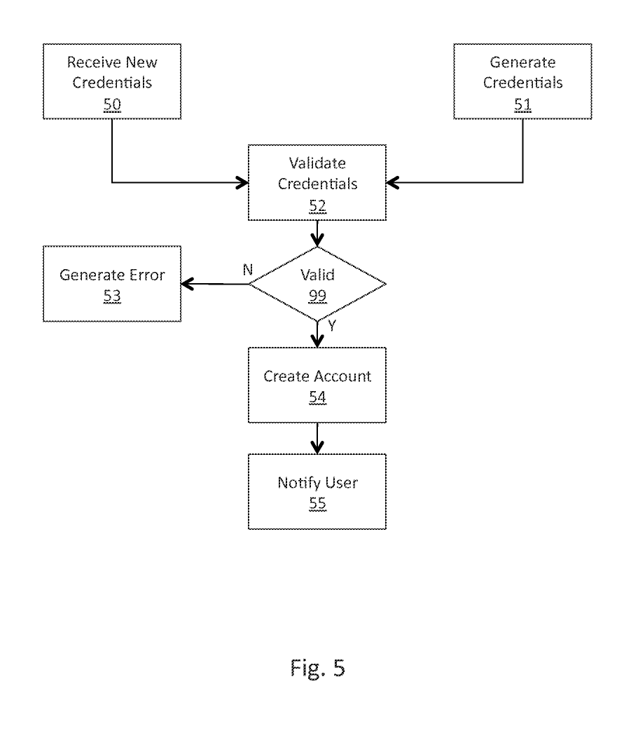

FIG. 5 is a flow diagram showing the creation of an account on the work order audit system according to selected embodiments of the current disclosure. Credentials must be created to associate a user with the system. These credentials, such as a username and password combination, can be received by the system 50 when created by a user or generated by the system 51. In either case, these credentials need to be validated 52 to ensure that the same credentials (or username) are not already being used by the system. Furthermore, the password is preferably validated to ensure it is of sufficient strength, such as by requiring a minimum number and/or type of characters. If the credentials are not valid, an error is generated 53. In the case of user-generated credentials, the user is notified that they are invalid and new credentials should be submitted. In the case of system-generated credentials, the system generates a new set of credentials until valid credentials are generated. Upon receiving valid credentials, the work order audit system creates an account 54 and notifies the user 55 of the successfully created account and optionally the credentials.

After creating an account, a user may login to the system, preferably through a website, to setup certain settings to enable the user to efficiently and effectively use the system.

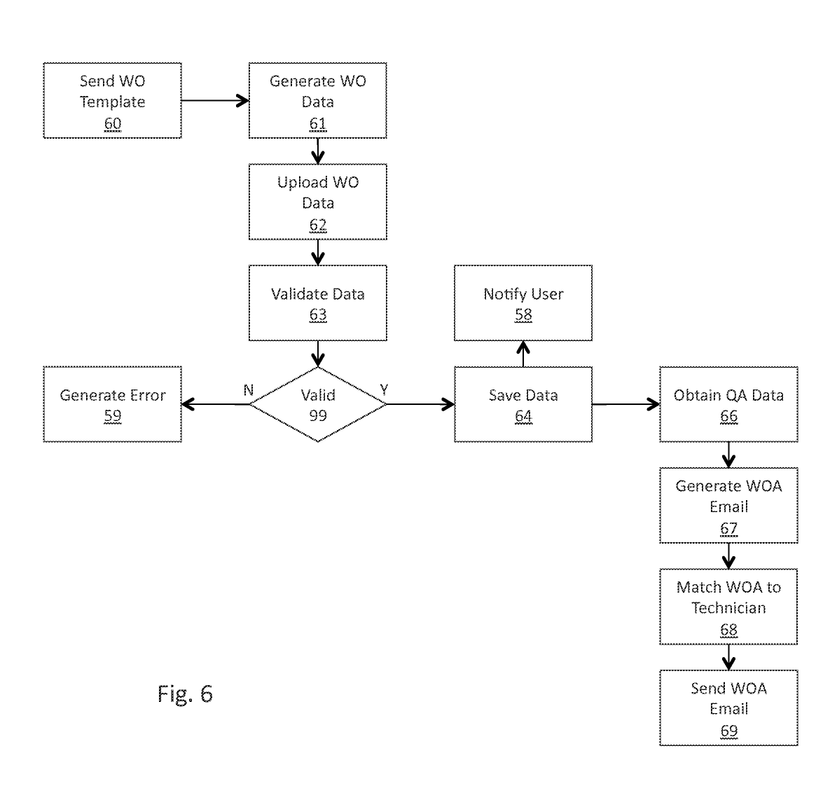

FIG. 6 is a flow diagram showing the acquisition of work order data into the work order audit system through the emailing of a work order audit to a technician according to selected embodiments of the current disclosure. To begin the process, work order data must be entered into the work order audit system. In this embodiment, the work order data is submitted as a CSV file, with each row representing a work order record.

To reduce errors in generating an appropriately formatted CSV file, a work order template is sent 60 to the user. This template has the field names filled in and optionally sample data. The fields of each record may include a work order number, asset management property number, development name, tenant name, building number, unit number, address, city, state, zip code, craft code, service or category code, service code description, sub-category code, call date, finish date, employee number, employee name, priority, total charged to tenant, total cost of repair, labor cost, materials cost, work order author, property manager, and maintenance supervisor. The user then fills in the template with the user's work order information, which may include multiple records, thereby generating the work order data 61.

The user then uploads the work order data 62 to the work order audit system. This is preferable achieved by logging into a website using the user's credentials and submitting the work order data through the website. Upon receiving the work order data, it is validated by the system. 63. If the system finds that the data is not valid 99, then it generates an error 59 and displays this error to the user through the website and allows the user to upload the work order data again. If the system finds that the data is valid 99, then it proceeds to save the data 64. The system will also notify the user 58 that the data was successfully validated and saved to the system, and that it will be processed accordingly.

After saving the data 64, the system processes each work order. The system must obtain question and answer data 66, where the question and answer data includes one or more questions and associated possible answers. There are a discrete number of possible answers for each question. In this particular embodiment, the selected questions are the same for all work orders.

The questions and associated answers (in parentheses) may include: is the description accurate (yes or no), is there a health and safety issue (yes or no), is the work completed (uncompleted work, completed work, abated work, or inconclusive work), what is the work quality (5—excellent, 4—above average, 3—average, 2—below average, or 1—poor), and should the tenant have been charged for the repair (yes or no). Preferably, between 2 and 7 questions are used in a work order audit. Too few questions do not provide sufficient data regarding the work performed, and too many questions result in an extensive amount of time to review a particular work order.

After the appropriate question and associated answers are obtained, the system generates a work order audit email 67. The email includes the relevant work order audit data, a unique identifier, and the questions and associated answers relevant to the work order audit. The unique identifier is used to associate a response to the work order audit with the work order previously saved into the system and may be located in the subject line of the email for ease of reference and processing by the system. Other data may be included with the email, such as instructions, contact information, technical support documentation, and other open ended questions that do not have a discrete number of possible answers.

In addition to obtaining the question and answer data and generating the work order audit email, the system matches the work order audit to a technician 68. The system includes a listing of one or more technicians that are capable of reviewing the work performed pursuant to a particular work order. The listing may include the technician's specialty, working hours, geographic region, compensation, and other relevant data. The system uses that data to match a technician to a work order audit. If multiple technicians meet the requirements of a particular work order, then the system may choose a particular technician systematically or randomly. Upon a successfully match, the system sends the work order audit email 69 to the technician.

While the system may automatically match a technician to a work order, it is nonetheless possible to have an individual review the work order and manually associate the work order with a technician separate from the system. This will slow down the process, but may allow for matching the most appropriate technician with the work order audit.

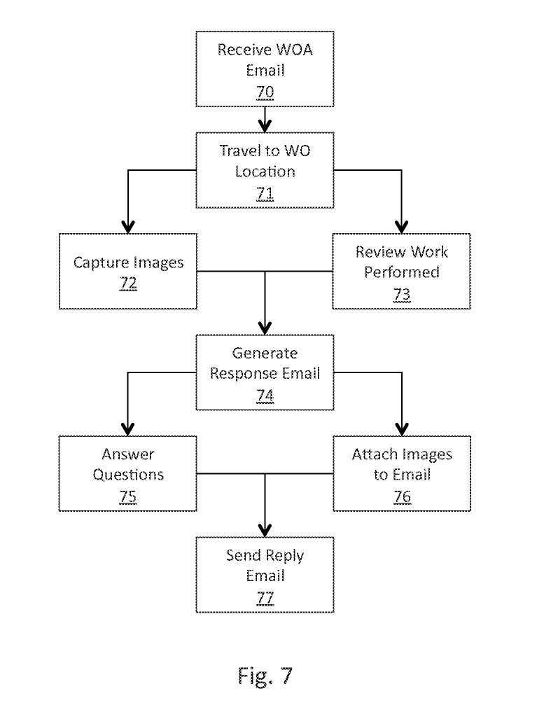

FIG. 7 is a flow diagram showing the steps taken by a technician to audit a work order and email the work order audit response back to the work order audit system according to selected embodiments of the current disclosure. Though not a part of the system, there is a preferred process that a technician should follow according to this selected embodiment of the current disclosure. First, the technician receives a work order audit email 70. The email includes the location that needs to be reviewed. If necessary, the technician may contact the tenant to set up a convenient time for the work order audit. Alternatively, the user of the system may notify a group of tenants of the technician and the audit of the work order. When appropriate, the technician travels to the location in which the work was performed pursuant to the relevant work order 71. Then, the technician captures one or more images 72 and reviews the work performed 73. After the review, the technician generates a work order audit response email 74, wherein the technician selects an answer to each question in the work order audit email 75 and attaches the one or more captured images 76. Additionally information may be included in the email, such as a description of the work performed from the technician's viewpoint. Finally, the technician sends the work order audit response email back to the system 77.

A technician captures the one or more images preferably using a digital camera. The image is captured by the digital camera and transferred to a computer, usually the same computer that is used to draft the work order audit response email. Images can be transferred to the computer through a cable, such as a USB cable or an Ethernet cable, or wirelessly, such as through an Eye-Fi™ memory card with integrated Wi-Fi™ wireless local area network connection or a Bluetooth connection. Once the images are stored on the computer, the technician can attach the images to an email through a standard email application such as Outlook™ by Microsoft™. The digital camera is preferably a single lens reflect camera to obtain high quality, high resolution images. Nonetheless, other types of digital cameras may be used, including smart phones with integrated digital cameras.

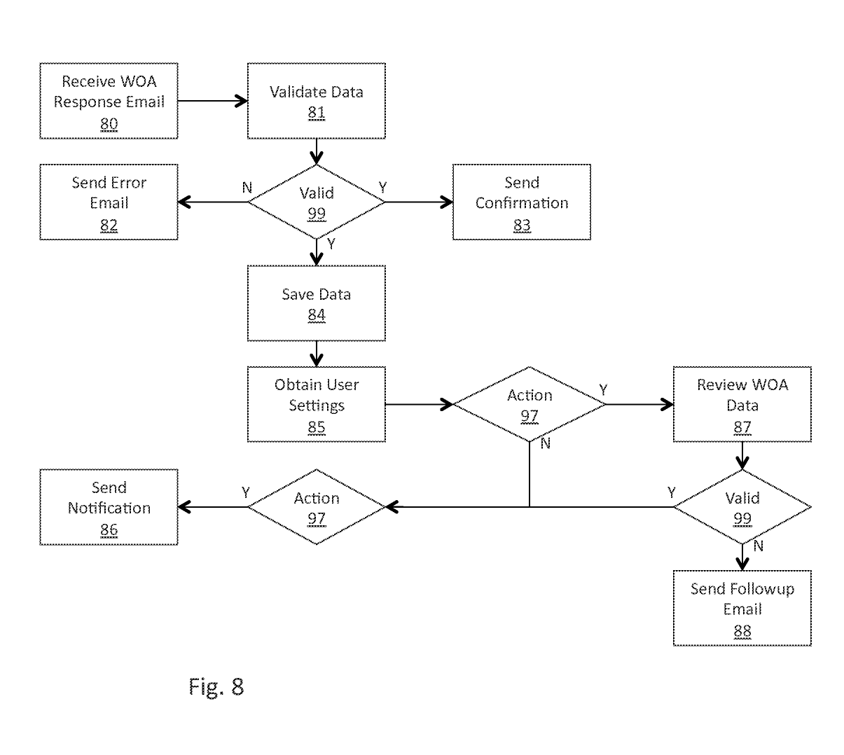

FIG. 8 is a flow diagram showing the acquisition of a work order audit response email and actions taken thereto according to selected embodiments of the current disclosure. The system receives the work order audit response email 80 from the technician and validates the data 81. If the data is not valid 99, then an error email is sent back to the technician 82. This email should specify the error, such as a missing answer to a question or no images attached, such that the technician may resolve the issue and send another work order audit response email. If the data is valid 99, then a confirmation email should be sent 83 to the technician confirming the successful response to a work order audit email. Upon a valid work order audit response email, the system should save the data 84 and the work order audit data with its corresponding work order data, using the unique identifier preferably contained within the subject of the email. This association is achieved by setting corresponding identifiers in a relational database.

The system should also obtain settings relevant to the user 85 to determine if any further review of the work order audit data is required. In certain instances, it is beneficial to have a second review of the work order audit response, such as to review the attached image(s), to further validate each work order audit response email. If such action 97 is requested by the user in their account settings, then the work order audit is flagged for review and a second review of the work order audit data 87 occurs. The review may include an individual verifying that the attached images agree with the answers given in the work order audit response email. If the second review of the work order audit data returns an invalid result 99, then a follow-up email is sent 88 to the technician associated with the work order audit to perform an additional review. However, if the second review of the work order audit data returns a valid result 99, or no second review action 97 is required, then the system continues on to determine if any further action is required. For example, one of the questions may be “Is further action required to complete the work order?” If the answer to this question is yes, then the system may take action 97. In this instance, the action would be to notify an individual such as the user 86 that further action is required for a specific work order.

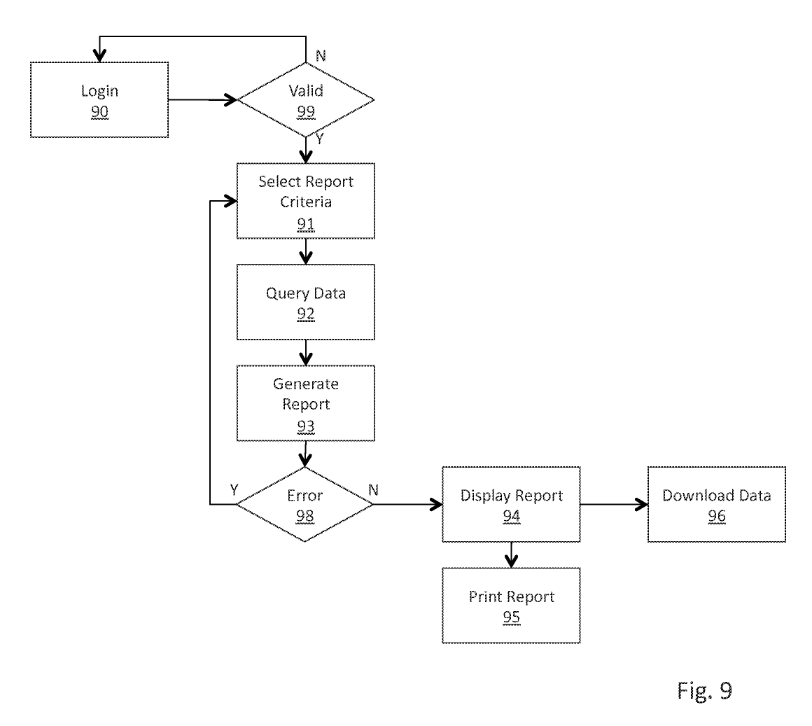

FIG. 9 is a flow diagram showing a user obtaining a report and/or data regarding work order audits according to selected embodiments of the current disclosure. To view reports on the work order audits associated with the user's account in the system, the user attempts to login 90 using his or her credentials. If the login is not valid 99, then the user is prompted to login 90 again. Upon a valid login 99, the user is prompted to select report/search criteria 91 and/or a particular type of report.

After selecting report criteria 91, the data is queried 92 and a report is generated 93. If there is an error 98 generating the report, such as if no records are found, the user is directed back to select different report criteria 91. However, if no error occurs 98, then the report is displayed to the user 94. The user may choose to print the report 95, including saving it as a PDF, or otherwise downloading the data 96.

As it will be appreciated from those practicing the current invention, a wide range of report types and search criteria may be used to generate various reports. For example, the types of reports can include a completion report, work quality report, tenant chargeback report, accuracy report, health and safety report, repair time report, employee summary report, and asset management project report. Report summaries may also be produced, wherein these reports include completion percentages, work quality rating totals, work quality rating averages, tenant chargeback amounts, missed chargeback amounts, accuracy percentages, health and safety percentages, averages for days to repair, total number of images, and total work orders. Furthermore, the reports may be limited by various search criteria or filters, including by batch, field tech, priority, status employee ID, zip code, craft, row display, work completion, building number, and work order ID. Images associated with reported work orders may be displayed, or links to those images made available.

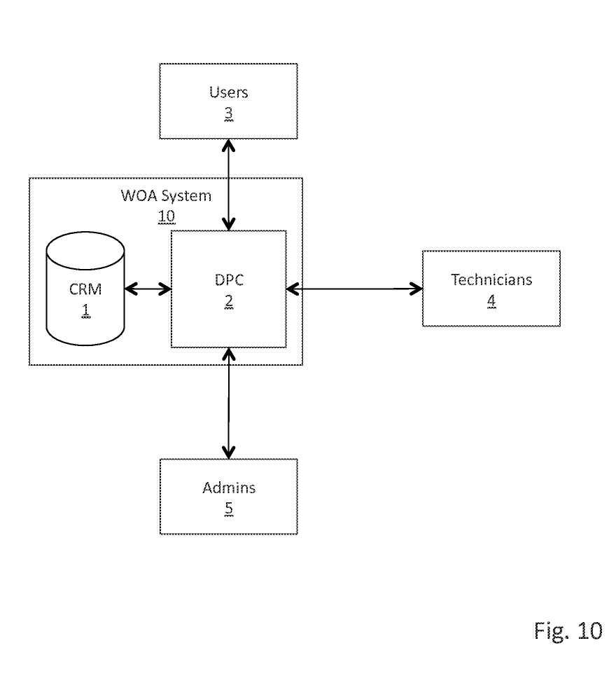

FIG. 10 is a schematic illustration of the work order audit system and its interactions with various entities according to embodiments of the current disclosure. The work order audit system 10 includes one or more data processing components 2, which include computer executable code that perform actions based upon various input. Data is stored in a computer readable medium 1 that is accessible by the data processing components 2 of the system. Users 3, Technicians 4, and Administrators 5 interact with the system and save, access, modify, and/or delete data through the data processing components 2.

The work orders, work order audits, user settings, and other associated data are preferably stored in a relational database on the computer readable medium. Using one or more relational databases enables the system to quickly and efficiently save and access data. This speed is especially important when generating reports from large amounts of data, such as an overall report of quality of work performed on thousands of units.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims are regarded as the invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A work order audit system comprising
one or more computer readable mediums configured to store data associated with work orders and work order audits,
one or more data processing components coupled to the one or more computer readable mediums, the one or more data processing components configured to:
import work order data,
generate a plurality of work order audits from the work order data,
group together a subset of the plurality of work order audits to form one or more groups of work order audits
match each group of work order audits to a technician,
transmit the matched group of work order audits to the technician,
receive a work order audit response,
save the work order audit response, and
generate one or more reports.

2. The system of claim 1, wherein the data processing components are further configured to validate the imported work order data.

3. The system of claim 1, wherein the one or more computer readable mediums are further configured to store technician data, where technician data comprises a name, contact information, available geographic areas, and available work types that the technician can audit.

4. The system of claim 1, wherein each work order audit comprises a plurality of questions and possible answers, where each question has a discrete number of possible answers, where the plurality of questions are between 2 and 7 questions.

5. (canceled)

6. The system of claim 4, wherein the work order audit response comprises answers to the plurality of questions.

7. The system of claim 1, wherein the work order audit response comprises one or more images.

8. The system of claim 7, wherein the one or more images are still digital images.

9. The system of claim 7, wherein the one or more images are video images.

10. The system of claim 1, wherein the work order data comprises one or more work orders, where each work order comprises a location and the work performed at that location.

11. A work order audit system comprising
one or more computer readable mediums configured to store data associated with work orders, work order audits, and technician data,
one or more data processing components coupled to the one or more computer readable mediums, the one or more data processing components configured to:
import work order data, wherein the work order data comprises one or more work orders, where each work order comprises a location and the work performed at that location,
generate one or more work order audits from the work order data, where each work order audit comprises a plurality of questions and possible answers, where each question has a discrete number of possible answers, where the plurality of questions are between 2 and 7 questions,
transmit the work order audit to a technician,
receive a work order audit response, where the work order audit response comprises answers to the plurality of questions and one or more images,
save the work order audit response, and
generate one or more reports,
where the technician data comprises a name, contact information, available geographic areas, and available work types that the technician can audit.

12. The work order audit system of claim 11, wherein the one or more images are still images.

13. The work order audit system of claim 11, wherein the system transmits the work order audit to a technician by sending an email to the technician.

14. The work order audit system of claim 11, wherein the system receives a work order audit response in the form of an email.

15. The work order audit system of claim 11, wherein the data processing components are further configured to validate the imported work order data.

16. The work order audit system of claim 11, wherein the data processing components are further configured to validate the received work order audit response.

17. The work order audit system of claim 11, wherein the data processing components are further configured to notify a user depending upon the answers of the work order audit response.

18. A work order audit system comprising
one or more computer readable mediums configured to store data associated with work orders, work order audits, and technician data,
one or more data processing components coupled to the one or more computer readable mediums, the one or more data processing components configured to:
import work order data from a file, wherein the work order data comprises one or more work orders, where each work order comprises a location and the work performed at that location,
generate one or more work order audits from the work order data, where each work order audit comprises a plurality of questions and possible answers, where each question has a discrete number of possible answers,
match each work order audit to a technician
email the work order audit to the technician,
receive a work order audit response email, where the work order audit response comprises answers to the plurality of questions and one or more images,
save the work order audit response,
where the technician data comprises a name, contact information, available geographic areas, and available work types that the technician can audit.

19. The work order audit system of claim 18, wherein the data processing components are further configured to notify a user depending upon the answers of the work order audit response email.

20. The work order audit system of claim 18, wherein the data processing components are further configured to generate one or more reports, where a user may select one or more criteria in generating the report.

21. The work order audit system of claim 18, wherein the one or more data processing components are further configured to:
validate the work order audit response email; and
send a reply email to the technician in reply to the work order audit response email, where the reply email comprises an error if the work order audit response email is not valid, where the reply email comprises a confirmation if the work order audit response email is valid.
